(19) United States
(12) Patent Application Publication
(10) Pub. No.: US 2026/0140318 A1
(43) Pub. Date: May 21, 2026

(54) MICRO-DISK RESONATOR WITH PRECISE DEPLETION LAYER

(71) Applicant: INTERNATIONAL BUSINESS MACHINES CORPORATION, Armonk, NY (US)

(72) Inventors: Qianwen Chen, Fort Collins, CO (US); Neng Liu, Albany, NY (US); Hsianghan Hsu, Latham, NY (US); John Knickerbocker, Monroe, NY (US)

(21) Appl. No.: 18/955,014

(22) Filed: Nov. 21, 2024

(51) Int. Cl. G02B 6/293

(52) U.S. Cl. CPC G02B 6/29338

(57) ABSTRACT

A semiconductor device includes a first doped region of a first conductivity type and a second doped region of a second conductivity type different from the first conductivity type. A fusion bonded insulating layer is disposed between the first doped region and the second doped region, wherein the fusion bonded insulating layer forms a tuned depletion layer disposed between the first doped region and the second doped region to form a P-I-N junction.

### BACKGROUND

The present invention generally relates to semiconductor devices and processing methods, and more particularly to micro-disks having a controlled depletion layer thickness.

A data center houses computer systems and associated components, such as telecommunications and storage systems. An important element in a data center includes transceiver devices, which include optoelectronic modulators. Si-based optoelectronic modulators include a vertical P-N junction, which provides low power consumption, low-voltage operation, high-speed, and is compact in size. However, conventional fabrication of a vertical P-N junction micro-disk resonator requires four ion doping/implantation steps on a single silicon-on-insulator (SOI) substrate. The number of ion doping/implantation steps can cause damage, disrupting the crystalline structure of the substrate. This can result in performance issues, which can include difficulty in getting a carrier-free depletion region between P-doped and N-doped regions (resulting in optical loss) and changing carrier concentrations with applied voltage (resulting in output frequency shifts).

### SUMMARY

In accordance with an embodiment of the present invention, a semiconductor device includes a first doped region of a first conductivity type and a second doped region of a second conductivity type different from the first conductivity type. A fusion bonded insulating layer is disposed between the first doped region and the second doped region, wherein the fusion bonded insulating layer forms a tuned depletion layer disposed between the first doped region and the second doped region to form a P-I-N junction.

In accordance with another embodiment of the present invention, a semiconductor device includes a micro-disk resonator including a P-I-N junction and a bus waveguide spaced apart by a distance. The PIN-junction includes a first doped region of a first conductivity type and a second doped region of a second conductivity type different from the first conductivity type. A fusion bonded insulating layer is disposed between the first doped region and the second doped region. The fusion bonded insulating layer includes two separately formed dielectric layers, wherein the fusion bonded insulating layer forms a tuned depletion layer disposed between the first doped region and the second doped region to form the P-I-N junction.

In accordance with another embodiment of the present invention, a method of fabricating a semiconductor device includes forming a first doped region of a first conductivity type on a first substrate; forming a second doped region of a second conductivity type on a second substrate; depositing a first dielectric layer on the first doped region; depositing a second dielectric layer on the second doped region; bonding the first dielectric layer to the second dielectric layer to form a fusion bonded insulating layer; and forming a P-I-N junction from the first doped region, the fusion bonded insulating layer, and the second doped region.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures, wherein:

FIG. 1 is a top view and a cross-sectional view (not to scale) showing a semiconductor device that forms a micro-disk resonator in accordance with, in accordance with an embodiment of the present invention;

FIG. 2 is a cross-sectional view showing two separate silicon-on-insulator substrates having separately formed doped regions thereon, in accordance with an embodiment of the present invention;

FIG. 3 is a cross-sectional view showing the two separate silicon-on-insulator substrates having separately formed bonding layers (dielectric layers) formed over the doped regions, in accordance with an embodiment of the present invention;

FIG. 4 is a cross-sectional view showing one of the two separate silicon-on-insulator substrates flipped and the separately formed bonding layers bonded to each other, in accordance with an embodiment of the present invention;

FIG. 5 is a cross-sectional view showing the flipped silicon-on-insulator substrate removed, in accordance with an embodiment of the present invention;

FIG. 6 is a cross-sectional view showing a structure etched to define bus waveguides and remove portions of thin semiconductor layers of the silicon-on-insulator substrates, in accordance with an embodiment of the present invention;

FIG. 7 is a cross-sectional view showing a dielectric layer (e.g., cladding layer) formed in etched openings and planarized, in accordance with an embodiment of the present invention;

FIG. 8 is a cross-sectional view showing the dielectric layer patterned to form contact openings and fill the contact openings to form metal contacts and complete a micro-disk resonator, in accordance with an embodiment of the present invention.

### DETAILED DESCRIPTION

In accordance with embodiments of the present invention, devices and methods are described which include micro-disk resonators, which are photonic devices that include a circular disk-shaped waveguide fabricated from a high refractive index material such as, e.g., silicon. The disk may be surrounded by a lower refractive index material, often air or silicon dioxide. Light may be coupled into the disk through an adjacent waveguide positioned close to the disk's edge. In some embodiments, micro-disk resonators can have light circulate around the disk's perimeter by total internal reflection. Resonant frequencies of these modes may depend on the disk's size and material properties. When the wavelength of the input light matches a resonant mode, the light may build up in intensity within the disk.

Micro-disk resonators find applications in various photonic devices and systems. Micro-disk resonators may be employed as optical filters, where specific wavelengths are selectively transmitted or reflected. Micro-disk resonators may be employed in optical switching and modulation applications.

The fabrication of micro-disk resonators includes semiconductor processing techniques. This may include lithography to define the disk shape, etching to create the disk structure, and deposition steps to form cladding layers or electrodes for active devices. Micro-disk resonators may be integrated with other photonic and electronic components on a single chip. This integration may enable the development of complex photonic circuits for applications in optical communication, sensing, and information processing.

In accordance with embodiments of the present invention, a micro-disk includes a P-doped-insulator-N-doped (P-I-N) junction, with a precise layer (I layer) between the N-doped and P-doped regions. The precision of the I layer can be achieved by separately forming the N-doped region on a first substrate and a P-doped region on a second separate substrate. For example, a P-doped region (P and P+ doping) can be provided on a first semiconductor-on-insulator (SOI) substrate with optimized process conditions. An N-doped region (N and N+ doping) can be provided on a second SOI substrate with optimized process conditions.

An insulating layer can be deposited on both SOI substrate surfaces using a high precision process, e.g., a plasma enhanced chemical vapor deposition (PECVD) process. A planarization process, such as chemical mechanical polishing (CMP) can be employed to prepare surfaces of the dielectric layer formed on the two SOI substrates for fusion bonding. The insulating layers can include barrier layers, such as, e.g., SiN or SiCN, etc. A final thickness of the dielectric layer can be precisely controlled, and can include a thickness of, e.g., 2-5 nm to a few microns (e.g., 2-3 microns), depending on the N-P junction depletion layer thickness needed.

One substrate is flipped to permit the dielectric layers to be in contact, and the substrates are bonded at the dielectric layers using, e.g., a fusion bonding process. A top substrate is removed to expose a top doped region. A bus waveguide and an N-P junction are patterned in the top doped region using an anisotropic etch (e.g., reactive ion etching (RIE)). Metal contacts are fabricated to both the N-doped region and the P-doped region.

A micro-disk based on a vertical P-I-N junction in accordance with embodiments of the present invention includes a precise depletion layer between N-doped and P-doped regions. P-doped and N-doped regions are separately fabricated on two SOI substrates with optimized process conditions, then fusion bonded to make a vertical P-I-N junction where the depletion layer/barrier eliminates carrier-induced optical loss and reduces or eliminates frequency shift.

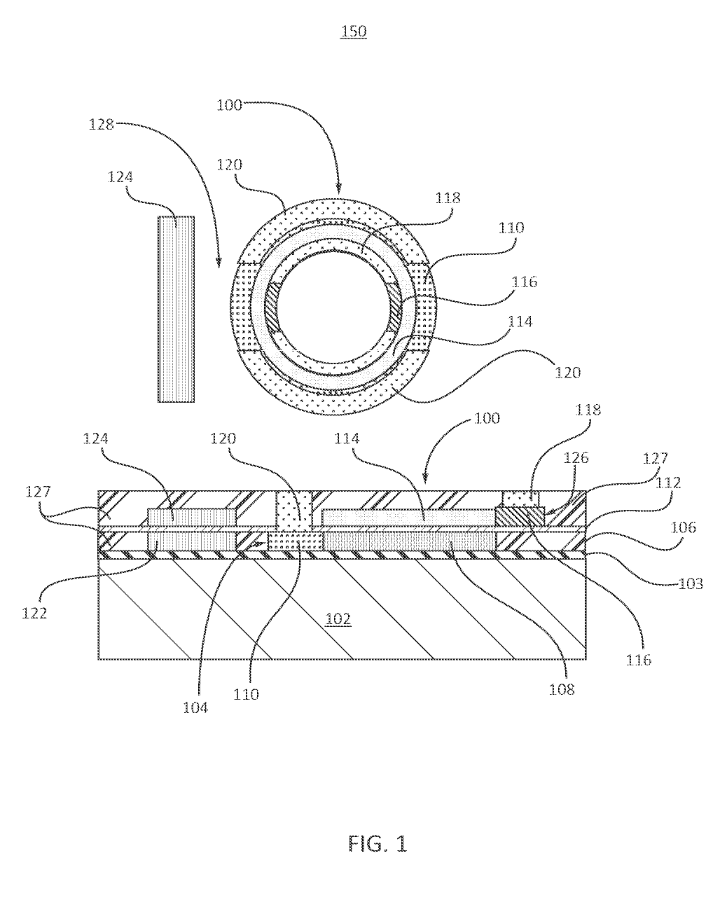

Referring now to the drawings in which like numerals represent the same or similar elements and initially to FIG. 1, a micro-disk resonator 150 is shown in accordance with an embodiment of the present invention. The micro-disk resonator 150 includes a micro-disk 100, which is formed on a silicon-on-insulator (SOI) substrate. The silicon-on-insulator (SOI) substrate may include a layered structure including a thin layer 104, e.g., of silicon, on top of an insulating layer 103. The insulating layer 103 can include, e.g., silicon dioxide (SiO₂), also referred to as a buried oxide (BOX), although other dielectric materials can be employed. The insulating layer 103 may be formed on a handle wafer 102 (or substrate). The thin layer 104, can be referred to as a device layer used for fabricating semiconductor devices, and in particular, for forming doped regions 108, 110 and bus waveguide 122 while the insulating layer 103 provides electrical isolation from the underlying handle wafer 102.

The handle wafer 102 can have a single layer or multiple layers. The handle wafer 102 can include a monocrystalline semiconductor. In one example, the handle wafer 102 can include a silicon-containing material. Illustrative examples of Si-containing materials suitable for the handle wafer 102 can include, but are not limited to, Si, SiGe, SiGeC, SiC and multi-layers thereof. Although silicon is the predominantly used semiconductor material in wafer fabrication, alternative semiconductor materials can be employed as additional layers, such as, but not limited to, germanium, gallium arsenide, gallium nitride, silicon germanium, cadmium telluride, zinc selenide, etc.

While the thin layer 104 is preferably silicon, the thin layer 104 can include other semiconductor materials. For example, the thin layer 104 can have a single layer or multiple layers. The thin layer 104 can include a monocrystalline semiconductor. In one example, the thin layer 104 can include a silicon-containing material. Illustrative examples of Si-containing materials suitable for the thin layer 104 can include, but are not limited to, Si, SiGe, SiGeC, SiC and multi-layers thereof. In other embodiments, III-V or other semiconductor materials can be employed.

A thin layer 126 is included from another SOI substrate as will be described herein. The thin layer 126 can include the same or different materials as the thin layer 104. The thin layer 126 is employed in forming devices, and in particular, for forming doped regions 114, 116 and bus waveguide 124.

Doped regions 108, 110 and bus waveguide 122 and doped regions 114, 116 and bus waveguide 124 are separated by a bonding layer 112. The bonding layer 112 is formed from portions on separate substrates using high precision processing to provide a highly precise thickness. The thickness of the bonding layer 112 can be controlled or tuned to within a 1- 2 nm and includes an overall thickness of between about 2 nm and about 3 microns. In a particularly useful embodiment, the bonding layer 112 can be about 10 nm. The thickness of the bonding layer 112 will depend on the function of the micro-disk 100 and the optical signals for which it is designed to handle.

The bonding layer 112 provides an insulator disposed between doped regions 108, 110 and bus waveguide 122 and doped regions 114, 116 and bus waveguide 124. The bonding layer 112 functions as a depletion layer between doped regions 108 and 114. Doped regions 108, 114 and the bonding layer form a P-I-N junction, where the precision of the depletion layer in the P-I-N junction provides a more stable carrier concentration leading to a reduction in optical loss and a reduction in frequency shift.

In an embodiment, doped region 108 can include an N or N+ doped region and doped region 114 can include a P or P+ doped region or vice versa. A contact pad (doped region 110) is integrally formed with the doped region 108 and includes a same dopant conductivity. Contact pad (doped region 110) can include a higher dopant concentration than the doped region 108 to improve electrical conductivity with a contact 120. A contact pad (doped region 116) is integrally formed with the doped region 114 (main portion) and includes a same dopant conductivity. Contact pad (doped region 116) can include a higher dopant concentration than the doped region 114 (main portion) to improve electrical conductivity with a contact 118.

Bus waveguides 122 and 124 correspond to doped regions 108 and 114, respectively. Bus waveguides 122 and 124 are used to couple light into and out of the micro-disk 100. The bus waveguides 122 and 124 can include a linear waveguide positioned in close proximity to the edge of the micro-disk 100. This proximity permits for evanescent coupling between the bus waveguides 122 and 124 and the micro-disk 100.

The bus waveguides 122 and 124 can be fabricated from the same high refractive index material as the micro-disk 100, such as silicon, or it may be made from a different material with suitable optical properties. In some cases, the bus waveguide 122, 124 can be designed to have a width and height that support single-mode operation at a wavelength of interest.

A gap 128 between the bus waveguides 122, 124 and the micro-disk 100 affects coupling efficiency. This gap 128 can be on the order of hundreds of nanometers, although the exact dimension may depend on factors such as the operating wavelength, material properties, and desired coupling strength.

In some embodiments, the bus waveguides 122, 124 can be tapered as they approach the micro-disk 100 to improve mode matching and increase coupling efficiency. The bus waveguides 122, 124 can be curved to wrap partially around the micro-disk 100, potentially increasing the interaction length and permitting stronger coupling. The position of the bus waveguides 122, 124 relative to the micro-disk 100 can be precisely controlled during fabrication to achieve the desired coupling characteristics. Multiple bus waveguides 122, 124 can be used with a single micro-disk 100 to enable more complex functionalities, such as add-drop filtering or bidirectional coupling.

A dielectric layer 127 is formed over the micro-disk resonator 150 to protect components and to function as a cladding material for the bus waveguides 122, 124. The dielectric layer 127 can be deposited over the bus waveguides 122, 124 to provide optical confinement and protect the waveguide structures. The cladding material may have a lower refractive index than the bus waveguides core to ensure light remains guided within the waveguide. Materials such as silicon dioxide, silicon nitride, or polymers may be employed as cladding layers.

The micro-disk resonator 150 in accordance with embodiments of the present invention provides an optical device structure with a stacked structure having a P doped layer and an N doped separated by an insulation layer to form a P-I-N junction. P+ doped material of one of the contact pads is connected with the P doped layer, and N+ doped material of one of the contact pads is connected with N doped layer for better contact. The P doped layer and the N doped layer include monocrystalline semiconductor material and are aligned without any or a minimum shift therebetween. This means the main portion of the doped layers (N and P) share a same footprint without a relative offset between the doped layers. This results in more carrier uniformity at the junction and therefore better performance. An insulation layer or bonding layer between the P doped layer and the N doped layer can be a few nanometers thick (e.g., 2-5 nm) and include, e.g., SiO₂ or SiN. The P-I-N junction structure is provided on a same device as bus waveguides 122, 124 to form the micro-disk resonator 150.

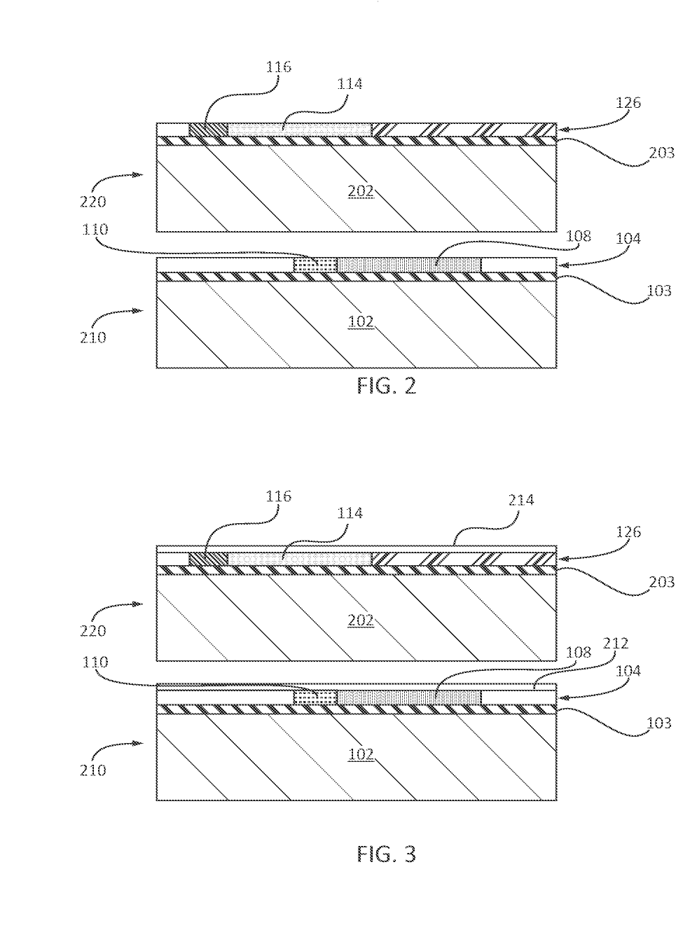

Referring to FIG. 2, a method for fabricating a micro-disk resonator is described and shown in accordance with embodiments of the present invention. A first semiconductor-on-insulator (SOI) substrate 210 and a second SOI substrate 220 are separately provided. The second SOI substrate 220 includes a similar structure and materials as the first SOI substrate 210 including an insulating layer 203 between a handle wafer 202 and the thin layer 126. The first SOI substrate 210 is masked to pattern doped regions 108, 110. The doped regions 108 and 110 can be doped together and/or separately using ion implantation methods or other doping methods. In an embodiment, the doped region 108 can include N type dopants while the doped region 110 can include a higher concentration of N type dopants (e.g., P, As, etc.).

The second SOI substrate 220 is masked to pattern doped regions 114, 116. The doped regions 114 and 116 can be doped together and/or separately using ion implantation methods or other doping methods. In an embodiment, the doped region 114 can include P type dopants while the doped region 116 can include a higher concentration of P type dopants (e.g., B, Ga, etc.). Because the first SOI substrate 210 and the second SOI substrate 220 are processed separately optimized process conditions are provided for each doping type resulting in higher quality semiconductor structures.

Referring to FIG. 3, a dielectric layer 212 is deposited on the first SOI substrate 210 over the thin layer 104, which includes the doped regions 108 and 110. A dielectric layer 214 is deposited on the second SOI substrate 220 over the thin layer 126, which includes the doped regions 114 and 116. The dielectric layers 212 and 214 can be deposited on both SOI substrate surfaces (SOI substrate 210 and SOI substrate 220) using a high precision process, such as plasma enhanced chemical vapor deposition (PECVD).

The surfaces of the dielectric layers 212 and 214 on both SOI substrates 210, 220 are planarized using a process such as chemical mechanical polishing (CMP) to prepare them for fusion bonding. The CMP process permits the layer’s thickness to be honed to collectively provide a precise insulating layer between the thin layers 104 and 126. The collective thickness of the two dielectric layers 212 and 214 can be maintained to within 2-5 nm with an overall thickness of between about 10 nm to a few microns (3-5 microns), as needed.

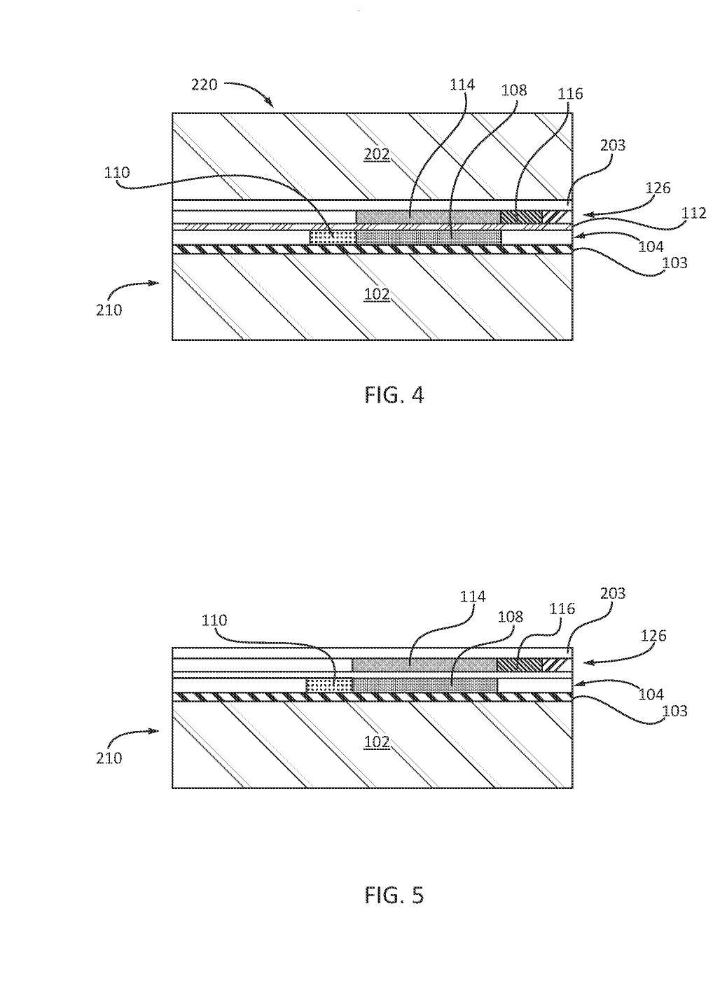

Referring to FIG. 4, the second SOI substrate 220 is flipped and fusion bonded to the first SOI substate 210 combining dielectric layers 212 and 214 to form bonding layer 112. This includes flipping one substrate and aligning it with the other substrate so that the dielectric layers are in contact. Fusion bonding includes bringing two highly polished and cleaned dielectric surfaces into close contact and allowing them to adhere through van der Waals forces and chemical bonds. The process may begin with surface preparation, which can include chemical cleaning to remove contaminants and activation treatments to increase surface reactivity. In some cases, the surfaces may be exposed to plasma or chemical solutions to create hydroxyl groups that can form strong bonds.

The dielectric layers 212 and 214 may then be aligned and pressed together under controlled temperature and pressure conditions. The initial contact may occur at room temperature, with subsequent annealing at elevated temperatures to strengthen the bond. The annealing temperature may vary depending on the materials involved, but can range from 200°C to over 1000°C for some embodiments.

During the annealing process, the interface between the dielectric layers 212 and 214 undergoes chemical reactions, leading to the formation of covalent bonds. For silicon dioxide layers, this can include condensation of silanol groups (Si-OH) to form siloxane bonds (Si-O-Si). The bonding process may also cause the diffusion of water molecules away from the interface, further strengthening the bond.

In some embodiments, the fusion bonding process may be performed in a vacuum or inert atmosphere to prevent the formation of voids or trapped gases at the interface. The bonding strength may be influenced by factors such as surface roughness, cleanliness, and the presence of intermediate layers.

Fusion bonding of dielectric layers 212, 214 maintains a thickness of the two layers to a high precision to form the bonding layer 112. The bonding layer 112 is a high-quality interface that provides a depletion layer for the P-I-N junction.

The depletion layer thickness in the P-I-N junction may be precisely controlled through the fabrication process of the micro-disk resonator. The thickness of the depletion layer or the bonding layer 112 can be tuned by adjusting various parameters during the fabrication process, e.g., by varying the deposition conditions of the dielectric layers on each substrate. For example, the PECVD process used to deposit the dielectric layers 212 and 214 may be optimized by adjusting parameters such as gas flow rates, chamber pressure, RF power, and deposition time to achieve the desired layer thickness.

Additionally, the planarization process applied to the dielectric layers 212 and 214 prior to bonding may be used to fine-tune the thickness. CMP may be employed to precisely control the final thickness of each dielectric layer before bonding. The CMP process parameters, such as polishing time, pressure, and slurry composition, may be adjusted to achieve the desired thickness with high precision. The bonding process can include high temperatures and pressures, which can cause slight changes in the thickness of the bonded layers. By carefully controlling the bonding parameters, such as temperature, pressure, and duration, the final thickness of the insulating layer may be further tuned.

The ability to precisely control the depletion layer thickness to provide a tuned depletion layer (bonding layer 112) permits optimization of the micro-disk resonator's performance. In some cases, a thinner depletion layer may result in stronger coupling between the P and N regions, potentially leading to improved modulation efficiency. Conversely, a thicker depletion layer may provide better electrical isolation and reduced capacitance, which could be beneficial for high-speed operation. Furthermore, the thickness of the depletion layer may be tailored to specific wavelengths of light used in the micro-disk resonator. By adjusting the depletion layer thickness, the optical properties of the P-I-N junction may be tuned to optimize performance for particular applications or operating conditions.

Referring to FIG. 5, the handle wafer 202 of the second substrate 220 is removed by an etch process. The etch process can include, e.g., a wet etch or dry etch. The etch process stops on the insulating layer 203.

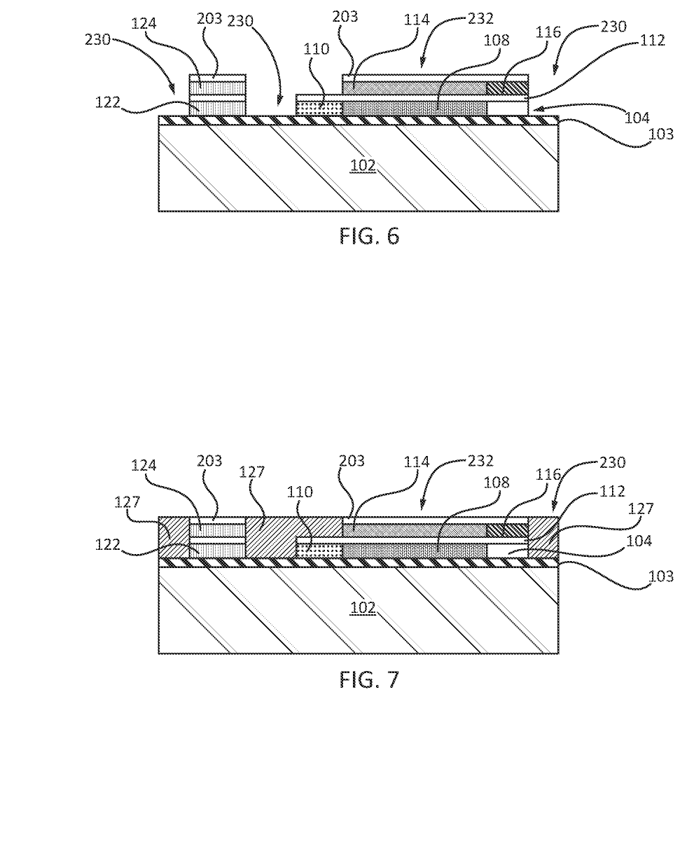

Referring to FIG. 6, a patterning process or processes are performed to etch down to the bonding layer 112 and insulating layer 103 in regions 230. The etch process patterns the bus waveguides 122 and 124 a precise distance from the P-I-N junction 232. The patterning process(es) can include the use of a photoresist mask and lithography process. A photoresist layer (not shown) may be deposited on top of the insulating layer 203. The photoresist can then be exposed to light through a photomask that defines the desired pattern for the bus waveguides 122, 124 and P-I-N junction 232.

After exposure and development, the photoresist mask may leave openings corresponding to the regions 230 where the bus waveguides 122, 124 and P-I-N junction 232 are to be formed. The mask pattern may be designed to position the bus waveguides 122, 124 at a specific distance from the P-I-N junction 232, which can be on the order of hundreds of nanometers. This distance may be precisely controlled through careful design of the photomask. An anisotropic etching process, such as reactive ion etching (RIE), may then be used to transfer the pattern from the photoresist mask to the underlying semiconductor layers. The photoresist mask may be removed after etching, leaving the bus waveguides 122, 124 and the P-I-N junction 232 patterned.

Referring to FIG. 7, a dielectric layer 127 is deposited over the micro-disk resonator and planarized to the insulating layer 203. The dielectric layer 127 can function as a cladding layer over the micro-disk resonator to protect components and provide optical confinement for the bus waveguides 122, 124. The dielectric layer 127 can be formed from materials such as silicon dioxide, silicon nitride, or polymers, which may have a lower refractive index than the core of the bus waveguides 122, 124. This layer can serve to enhance the optical confinement within the bus waveguides 122, 124 and protect the underlying structures from environmental factors and mechanical damage. The dielectric layer 127 can be deposited by CVD, PECVD, spin coating, etc. depending on the material and desired properties.

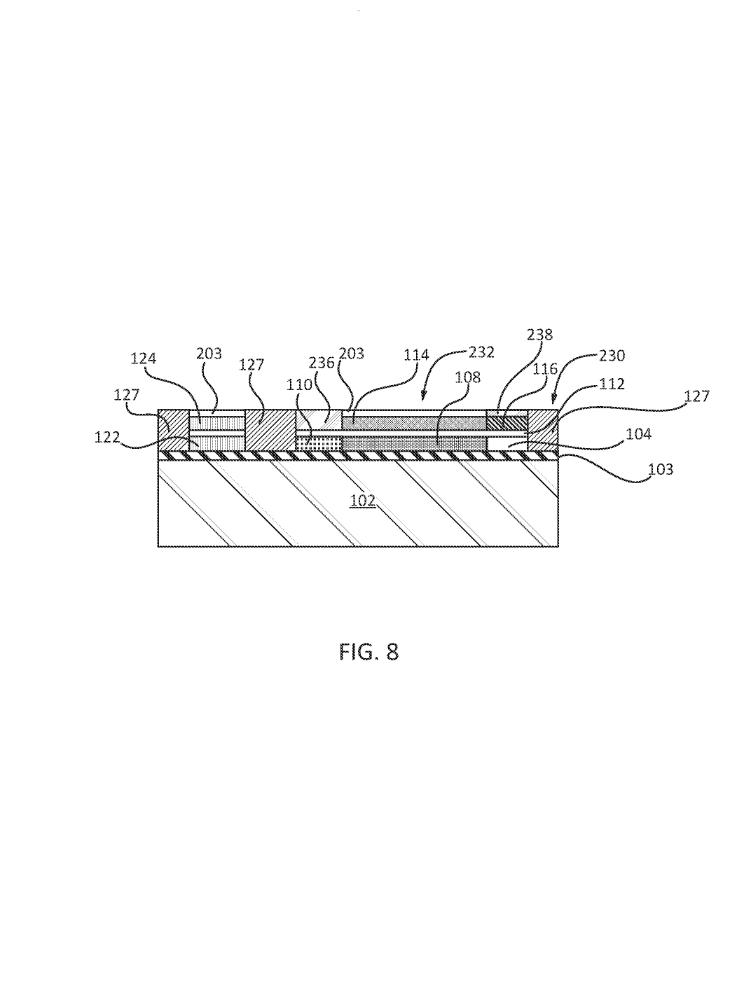

Referring to FIG. 8, metal contacts 236 and 238 are formed to doped portions of the P-I-N junction 232. The metal contact 236 connects to the doped region 108 through contact pad (doped region 110). The metal contact 238 connects to the doped region 114 through the contact pad (doped region 116).

The metal contacts 236 and 238 can be formed by patterning and etching the dielectric layer 127 to form contact openings that expose the contact pads (doped regions 110 and 116). A conductive fill is performed to fill the contact openings. The conductive fill can include materials, such as, e.g., W, Cu, Co, and alloys or combinations of these and other conductive materials. In a particularly useful embodiment, the conductive fill includes W. The conductive fill can be formed using a deposition method, such as, e.g., CVD, PECVD, ALD or any other suitable deposition method. The conductive fill is planarized, e.g., by CMP, to form the metal contacts 236 and 238.

Exemplary applications/uses to which the present invention can be applied include, but are not limited to semiconductor devices. Semiconductor devices can include processors, memory devices, application specific integrated circuits (ASICs), logic circuits or devices, combinations of these and any other circuit device. In such devices, one or more semiconductor devices can be included in a central processing unit, a graphics processing unit, and/or a separate processor- or computing element-based controller (e.g., logic gates, etc.). The semiconductor devices can include one or more on-board memories (e.g., caches, dedicated memory arrays, read only memory, etc.). In some embodiments, the semiconductor devices can include one or more memories that can be on or off board or that can be dedicated for use by a hardware processor subsystem (e.g., ROM, RAM, basic input/output system (BIOS), etc.).

In some embodiments, the semiconductor devices can include and execute one or more software elements. The one or more software elements can include an operating system and/or one or more applications and/or specific code to achieve a specified result. In still other embodiments, the semiconductor devices can include dedicated, specialized circuitry that perform one or more electronic processing functions to achieve a specified result. Such circuitry can include one or more field programmable gate arrays (FPGAs), and/or programmable applications programmable logic arrays (PLAs).

It is to be understood that aspects of the present invention will be described in terms of a given illustrative architecture; however, other architectures, structures, substrate materials and process features and steps can be varied within the scope of aspects of the present invention.

It will also be understood that when an element such as a layer, region or substrate is referred to as being “on” or “over” another element, it can be directly on the other element or intervening elements can also be present. In contrast, when an element is referred to as being “directly on” or “directly over” another element, there are no intervening elements present. It will also be understood that when an element is referred to as being “connected” or “coupled” to another element, it can be directly connected or coupled to the other element or intervening elements can be present. In contrast, when an element is referred to as being “directly connected” or “directly coupled” to another element, there are no intervening elements present.

The present embodiments can include a design for an integrated circuit chip, which can be created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer can transmit the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

Methods described herein can be used in the fabrication of integrated circuit chips. The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher level carrier) or in a multichip package (such as a ceramic carrier that has either or both surface interconnections or buried interconnections). In any case, the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

It should also be understood that material compounds will be described in terms of listed elements, e.g., SiGe. These compounds include different proportions of the elements within the compound, e.g., SiGe includes SiₓGe₁₋ₓ where x is less than or equal to 1, etc. In addition, other elements can be included in the compound and still function in accordance with the present principles. The compounds with additional elements will be referred to herein as alloys.

Reference in the specification to “one embodiment” or “an embodiment”, as well as other variations thereof, means that a particular feature, structure, characteristic, and so forth described in connection with the embodiment is included in at least one embodiment. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This can be extended, as readily apparent by one of ordinary skill in this and related arts, for as many items listed.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Spatially relative terms, such as “beneath,” “below,” “lower,” “above,” “upper,” “top,” “bottom” and the like, can be used herein for ease of description to describe one element's or feature's relationship to another element(s) or feature(s) as illustrated in the FIGS. It will be understood that the spatially relative terms are intended to encompass different orientations of the device in use or operation in addition to the orientation depicted in the FIGS. For example, if the device in the FIGS. is turned over, elements described as “below” or “beneath” other elements or features would then be oriented “above” the other elements or features. Thus, the term “below” can encompass both an orientation of above and below. The device can be otherwise oriented (rotated 90 degrees or at other orientations), and the spatially relative descriptors used herein can be interpreted accordingly. In addition, it will also be understood that when a layer is referred to as being “between” two layers, it can be the only layer between the two layers, or one or more intervening layers can also be present.

It will be understood that, although the terms first, second, etc. can be used herein to describe various elements, these elements should not be limited by these terms. These terms are only used to distinguish one element from another element. Thus, a first element discussed below could be termed a second element without departing from the scope of the present concept.

Having described preferred embodiments of devices and methods (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A semiconductor device, comprising:
a first doped region of a first conductivity type;
a second doped region of a second conductivity type different from the first conductivity type; and
a fusion bonded insulating layer disposed between the first doped region and the second doped region, wherein the fusion bonded insulating layer forms a tuned depletion layer disposed between the first doped region and the second doped region to form a P-I-N junction.

2. The semiconductor device of claim 1, wherein the fusion bonded insulating layer includes two separately formed dielectric layers.

3. The semiconductor device of claim 1, wherein the first doped region includes a main portion and a contact pad portion having a higher doping concentration.

4. The semiconductor device of claim 3, wherein the second doped region includes a main portion and a contact pad portion having a higher doping concentration.

5. The semiconductor device of claim 4, wherein the main portion of the first doped region and the main portion of the second doped region are aligned to share a footprint.

6. The semiconductor device of claim 1, wherein the fusion bonded insulating layer includes a thickness between about 2 nm and about 3 microns.

7. The semiconductor device of claim 1, wherein the fusion bonded insulating layer can be tuned to within 1-2 nm.

8. The semiconductor device of claim 1, further comprising at least one bus waveguide formed on a same substrate as the P-I-N junction.

9. A semiconductor device, comprising:
a micro-disk resonator including a P-I-N junction and a bus waveguide spaced apart by a distance, the P-I-N junction including:
a first doped region of a first conductivity type;
a second doped region of a second conductivity type different from the first conductivity type; and
a fusion bonded insulating layer disposed between the first doped region and the second doped region, the fusion bonded insulating layer including two separately formed dielectric layers, wherein the fusion bonded insulating layer forms a tuned depletion layer disposed between the first doped region and the second doped region to form the P-I-N junction.

10. The semiconductor device of claim 9, wherein the first doped region includes a main portion and a contact pad portion having a higher doping concentration.

11. The semiconductor device of claim 10, wherein the second doped region includes a main portion and a contact pad portion having a higher doping concentration.

12. The semiconductor device of claim 10, wherein the main portion of the first doped region and the main portion of the second doped region are aligned to share a footprint.

13. The semiconductor device of claim 10, wherein the fusion bonded insulating layer includes a thickness between about 2 nm and about 3 microns.

14. The semiconductor device of claim 10, wherein the fusion bonded insulating layer can be tuned to within 1-2 nm.

15. A method of fabricating a semiconductor device, comprising:
forming a first doped region of a first conductivity type on a first substrate;
forming a second doped region of a second conductivity type on a second substrate;
depositing a first dielectric layer on the first doped region;
depositing a second dielectric layer on the second doped region;
bonding the first dielectric layer to the second dielectric layer to form a fusion bonded insulating layer; and
forming a P-I-N junction from the first doped region, the fusion bonded insulating layer, and the second doped region.

16. The method of claim 15, wherein depositing the first dielectric layer and depositing the second dielectric layer includes separate plasma enhanced chemical vapor depositions.

17. The method of claim 15, further comprising separately planarizing surfaces of the first dielectric layer and the second dielectric layer prior to bonding.

18. The method of claim 15, wherein bonding the first dielectric layer to the second dielectric layer includes fusion bonding.

19. The method of claim 15, further comprising controlling a thickness of the fusion bonded insulating layer to within 1-2. nm.

20. The method of claim 15, further comprising forming at least one bus waveguide adjacent to the P-I-N junction.
